(19) United States
(12) Patent Application Publication
(10) Pub. No.: US 2003/0008041 A1
(43) Pub. Date: Jan. 9, 2003

(54) Fat-based confectionery product and method for making same

(76) Inventors: Christopher Budwig, Columbus, OH (US); Stephen J. DeStephen, Columbus, OH (US); David M. Klug, Marysville, OH (US)

Correspondence Address: WINSTON & STRAWN, PATENT DEPARTMENT, 1400 L STREET, N.W., WASHINGTON, DC, 20005-3502, US

(21) Appl. No.: 09/900,620

(22) Filed: Jul. 6, 2001

(51) Int. Cl. A23B 4/00

(52) U.S. Cl. 426/115

(57) ABSTRACT

The invention relates to a “push-up” package and delivery system for a fat-based confectionery, as well as a method of forming the package by in situ molding of the confectionery therein. The confectionery may be dispensed by pushing up on a plunger member through a chamber in the package. The chamber cross-section may be any shape including a circle, oval, polygon, such as a square, rectangle, trapezoid, or triangle, a star or cross, or a character shape.

### FIELD OF INVENTION

The present invention relates to a fat-based confectionery product as well as to a package and delivery system for such confectioneries. More particularly, the invention relates to a confectionery product in a “push-up” type package and delivery system, as well as methods of in situ molding of the confectionery within the delivery system itself.

### BACKGROUND OF THE INVENTION

Fat containing confectionery products traditionally have been provided in bar form as, for example, a chocolate bar. To make the product more desirable for consumers, other forms have been used, including balls and other shapes, with interiors that are hollow, solid or filled with other confectioneries.

PUSH-UP and PUSH-POP brand delivery systems have been used for frozen products, such as ice cream and water ices, and sugar confectionery products, such as lollipops. Typically, these systems consist of a cylindrical chamber used to “push up” and expose the product as it is being consumed by the user. Despite this well known use, such delivery systems have not been used in whole or in part for “fat-based confections” as defined below.

U.S. Pat. No. 6,187,350 discloses a confectionery product that includes a cylindrical housing with a base for supporting the confectionery product and a cap that encloses the product. The confectionery product is located in one end of the housing and a small toy is sealed in the opposite end of the housing.

Typically, fat-based confectionery products are provided to consumers in paper, fiber paper, foil, or flexible plastic film, which are not easily re-sealed to help preserve and protect a partially eaten product, e.g., they are not air- or water-tight. It is now desired to have a storable, reclosable fat-based confectionery product in a suitable delivery system.

### SUMMARY OF THE INVENTION

The invention relates to a confectionery product including a fat-based confectionery including at least one portion having from about 15 to 90 weight percent fat content, and delivery system for the confectionery. The delivery system includes a first chamber having first and second ends and a hollow interior within which the fat-based confectionery is disposed; and a slidable plunger member positioned in the first end of the chamber for engagement with the confectionery. Thus, when force is applied to the plunger member to move it toward the second end of the chamber, the confectionery is moved toward and out of the second end of the chamber and is exposed for consumption.

If desired, a handle attached to the plunger member can be provided on a side of the plunger opposite that which contacts the fat-based confectionery. Alternatively, a dial or button can be used to advance the confectionery. Also, it is advantageous to provide a removable end seal covering the second end of the chamber to protect the confectionery when the delivery system is not in use.

The chamber, plunger member, and confectionery are correspondingly shaped as a circle, oval, polygon, trapezoid, star, cross, or character shape, when viewed in cross-section taken perpendicularly along the length of the chamber. Optionally, the chamber can be made of a transparent material so that the fat-based confectionery is visible in the dispensing device. Preferably, at least one of the chamber or plunger member comprises polyethylene, polypropylene, polystyrene, polyethylene terephthalate, or a combination thereof.

If desired, at least one additional chamber can be provided adjacent and connected to the first chamber. Additionally, graduations can be placed on the first chamber to indicate amounts of fat-based confectionery therein. The fat-based confectionery can further comprise one or more inclusions.

The invention also relates to a method of forming a confectionery product. This method includes the steps of providing a chamber having first and second ends and a hollow interior; depositing a fat-based confectionery within the hollow interior of the chamber; and providing a slidable plunger member positioned in a first end of the chamber. As described above, when force is applied to the plunger member to move it toward the second end of the chamber, the confectionery is forced to move toward the second end and out of the chamber to expose the fat-based confectionery for consumption.

Advantageously, the chamber may also serve as a mold for the confection, eliminating the need for traditional molds. Also, the depositing step can advantageously include an in situ molding of the confectionery in the chamber utilizing the chamber as a mold. The in situ molding may also include coating the interior of the chamber with a first confectionery; and providing one or more additional confectioneries sequentially into the hollow interior of the coated chamber to form the confectionery product, wherein at least one of the confectioneries is fat-based. The confectioneries may also be co-deposited within the chamber.

At least one of the first and second fat-based confectioneries comprises from about 15 to 90 weight percent fat content. In one preferred embodiment, the first and second confectioneries are different compositions. Of course, the confectionery may include inclusions, such as chocolate pieces, cereal or grains such as oat flake pieces, raisins, fruit pieces, whole nuts or nut pieces, caramel, name-brand candies, or mixtures thereof.

Finally, the invention also relates to a method of dispensing a fat-based confectionery for consumption by forming a confectionery product as described herein and operating the plunger member in the chamber to force the confectionery out of the chamber to expose it for consumption. Operating the plunger member includes pushing upward on a stick relative to the delivery system container, twisting a dial on the outside of the body of the delivery system, pushing a release button to raise a platform holding the fat-based confectionery, or the like.

### BRIEF DESCRIPTION OF THE DRAWINGS

The invention will be better understood in relation to the attached drawings illustrating preferred embodiments, wherein:

FIG. 1 shows a perspective view of a delivery system of the present invention having a circular chamber and plunger member;

FIG. 2 shows a perspective view of a delivery system of the present invention having a triangular chamber and plunger member; and

FIG. 3 shows a perspective view of a delivery system of the present invention having multiple chambers.

### DETAILED DESCRIPTION OF THE INVENTION

The invention relates to a package and delivery system for fat-based confectioneries. The term “fat-based confectionery” refers to a confectionery that includes from about 15 to 90 weight percent of fat, oil, or both, in a portion of the delivery system. Preferably, the confectionery includes from about 20 to 80 weight percent fat. In one preferred embodiment, the fat content is from about 30 to 70 weight percent. Exemplary fat-based confectioneries include, but are not limited to, chocolate, compound coatings, nut pastes, caramel with fat-containing inclusions, and melt-aways.

The portions of the fat-based confectionery product including the fat content can be uniformly or non-uniformly distributed throughout the delivery device. For example, chunks of chocolate or other fat-based inclusions can be disposed in agglomerates in a sugar confectionery. Alternatively, a plurality of portions can be used, each of which can be a substantially or completely concentric layer of edible material, where at least one of the layers comprises a fat-based confectionery material, e.g., having from about 15 to 90 weight percent fat content. In one preferred embodiment, the outermost portion includes chocolate.

Suitable chocolates include sweet chocolate, milk chocolate, buttermilk chocolate, bittersweet chocolate, dark chocolate, or chocolates as defined in 21 C.F.R. § 163.

The term “compound coating,” as used herein, means any confectionery product based on vegetable fat or milk fat. Exemplary vegetable fats include palm oil, palm kernel oil, and coconut oil, or combinations thereof. In addition to vegetable fat, the confectionery coatings typically contain sugar; cocoa solids, peanut solids, and other natural or artificial flavors; emulsifiers; coloring agents; and optionally, milk solids. Other compound coatings, made from cocoa powder, non-fat milk powder, sugar, and one of the many vegetable fats, may have an appearance resembling dark or milk chocolate, but a texture that is quite different. Compound coatings include pastel coatings, which have no cocoa powder and have added colors and flavors. The compound coating can have a variety of flavors, including, but not limited to, maple, chocolate, peanut butter, and butterscotch.

The term “nut paste,” as used herein, refers to any nut content, such as ground or chopped nuts that are made into a paste. Preferred are nut pastes that are spreadable and flowable under ambient conditions to facilitate processing. Any type of nuts may be used including, but not limited to, almonds, pecans, hazelnuts, walnuts, peanuts, and mixtures thereof. “Nut pastes” can include other ingredients with the nut content, for example, one or more of salt, corn syrup, sugar, molasses, flavoring agent(s), emulsifier(s), stabilizing fat(s), chocolate, and compound coatings. For example, peanut butter can be a suitable nut paste for use according to the invention.

The term “melt-away,” as used herein, means a fat-based confection that typically uses the same primary ingredients as are commonly found in chocolates and compound coatings. Melt-aways are distinguished by their melting characteristic in the mouth and the resultant differing mouthfeel, e.g., creamier, smoother, or the like.

Typical examples of fat-based confectioneries include products such as NESTLE CRUNCH® bars, MARS® bars, SNICKERS® bars, M&M® chocolate candies, KIT KAT® bars, BABY RUTH® bars, BUTTERFINGER® bars, SMARTIES® candies, ROLO® candies, MILKY WAY® bars, and REESE'S® peanut butter cups. Typically, the fat-based confectionery is substantially free of ice cream or water ice; preferably, the confectionery is completely free of ice cream or water ice. The fat-based confectioneries are preferably softer products that deform under pressure more easily than harder sugar confectioneries, as these softer products typically provide a more desired mouthfeel.

Optionally, the confectionery may contain inclusions. Inclusions include, but are not limited to, chocolate pieces, cereals and grains such as oat flake pieces, raisins, fruit pieces, whole nuts or nut pieces, e.g., groundnuts, hazelnuts, or other nuts, name-brand candies, caramel, or various mixtures thereof. Exemplary name-brand candies for use as inclusions include SMARTIES, M&Ms, NERDS, or combinations thereof. The inclusions can include fat-based confectioneries. The inclusions can be of any edible size, and are typically about 1 mm to about 25 mm, preferably about 4 mm to about 10 mm in diameter. The amount of inclusions is not critical and can vary from about 1% to 80% by weight of the confectionery. In one embodiment, inclusions are included in an amount from about 5 to 40% by weight of the confectionery. Optionally, dark chocolate, milk chocolate, white chocolate, compound coatings, or mixtures thereof, may be used in the form of morsels, pellets, or chunks. When included, chocolate is typically present in an amount of about 5% to about 100%, preferably about 10% to about 50% by weight. The chocolate can be a commercial chocolate, a compound coating, or the like, or combinations thereof.

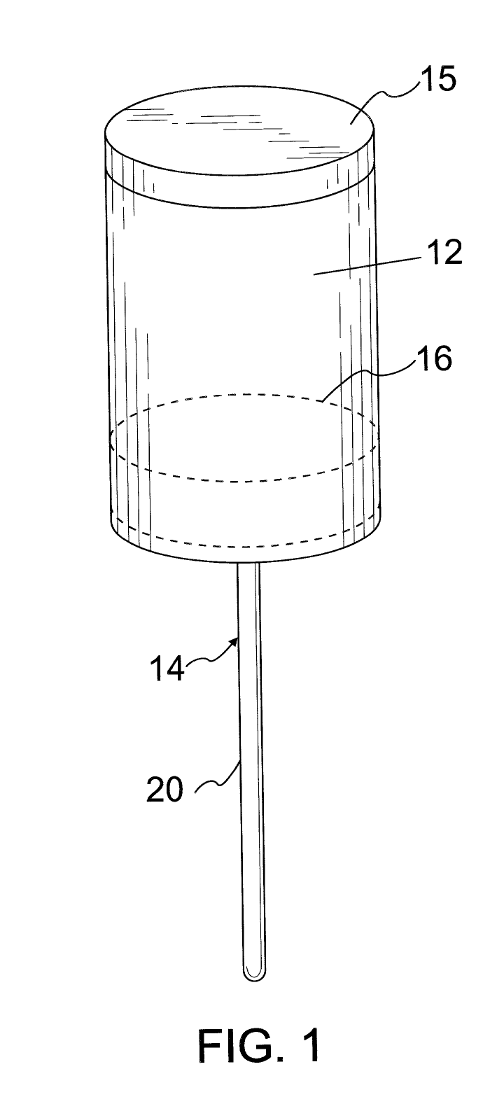

Referring to the drawings, FIG. 1 shows one embodiment of the invention having a hollow chamber 12 within which is a plunger member 14 that is slidably positioned. The plunger member 14 is positioned at one end of the chamber 12 and the fat-based confectionery is provided within the hollow interior of the chamber 12. When the plunger member 14 slides up through the chamber 12, the confectionery is forced up through the top of the chamber 12 for consumption by the user. A removable end seal 15 may optionally be provided to maintain the freshness of the confectionery prior to use, as well as after partial consumption. The end seal 15 may also be used to reseal the chamber 12 such that the confectionery need not be entirely consumed at once. Although the seal 15 shown in FIG. 1 is advantageously made of plastic that conforms to the chamber wall(s) when it is desired to reseal the chamber after use, any type of seal may be used that is known to those of ordinary skill in the art, such as paper or the like, when the chamber is not intended to be resealed. The seal 15 could be a cap, lid, hinge, screw top, or the like as will be readily appreciated by one of ordinary skill in the art. The seal may also include a design or decoration and may include elevation, as for example, a character head. In one embodiment, the seal is a snap on plastic cap. In a preferred embodiment, the plastic seal or closure for the one end of the hollow chamber is sufficiently rigid to prevent deformation of the product therein.

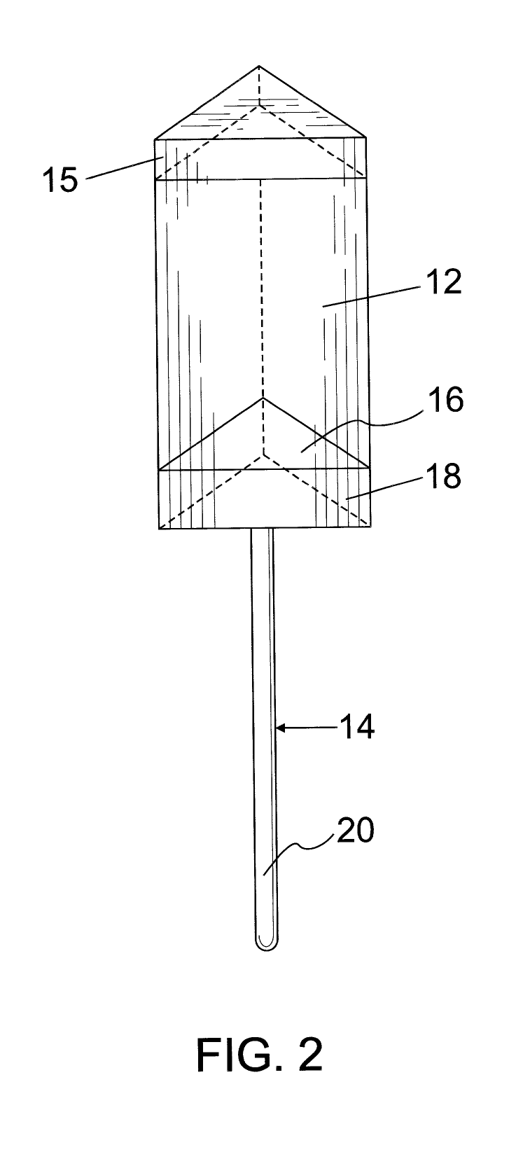

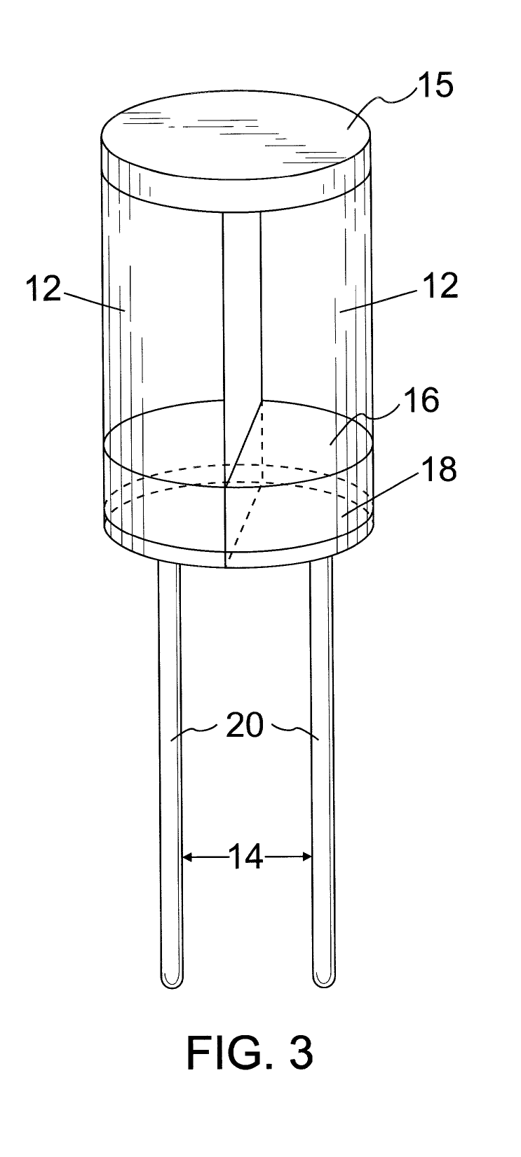

Although the chamber 12 and plunger member 14 shown in FIG. 1 are cylindrical, a wide variety of other shapes may alternatively be used, such as the triangular shaped chamber 12 and plunger member 14 shown in FIG. 2. The cross-section of the chamber 12 and plunger member 14 may also be, for example, any polygon, such as a square, rectangle, or trapezoid, or a shape such as an oval, star, or cross. Other irregular shapes may also be used, such as holiday shapes or character shapes. The chamber 12 may even contain multiple compartments, such as shown in FIG. 3, or there may be multiple chambers present in the device. Each chamber could then contain the same or a different confectionery.

The chamber 12 and plunger member 14 may be opaque or transparent, or one of them may be opaque and the other transparent. The transparent embodiment of the chamber 12 is preferred as it permits display of the confectionery. The outer surface of the chamber 12 or the plunger member 14 may be decorated in any number of ways known to those of ordinary skill in the art of packaging and labeling. The chamber 12 and the plunger member 14 may be made of paper, wood, or a suitable formable plastic material, such as polyethylene, polypropylene, polystyrene, polyethylene terephthalate (PET), or the like, or a combination thereof, that is resistant to deformation. In a preferred embodiment, the delivery system is sufficiently resistant to deformation that a consumer sitting on the product will not alter the shape of the fat-based confectionery within the chamber. This can permit a consumer to place a sealed delivery system of the invention within a back pocket without fear of damaging the delivery system. The chamber 12 and plunger member 14 may also be formed of any other suitable material known to those of ordinary skill in the art. It is not necessary that the chamber 12 and plunger member 14 be formed of the same materials, although in one embodiment, they are formed of the same material for ease of manufacturing.

The plunger member 14 may include a top portion 16 that is typically planar and engages the confectionery as the plunger member 14 is slid upwardly within the chamber 12. Alternatively, the top portion may be concave or convex to conform to the top of the confectionery. It may be colored or transparent. In a preferred embodiment, the plunger member 14 includes a peripheral side portion 18 that engages the inner walls of the chamber 12. The side portion 18 facilitates sliding the plunger member within the chamber 12.

The plunger member 14 may also include a handle 20 extending down opposite from the top portion 16 and out from the chamber. The user may hold the handle 20 when carrying or eating the confectionery. To force the confectionery from the chamber 12, the user will typically grasp the outer surface of the chamber 12 and push up on the handle 20. This will force the plunger member 14 up within the chamber 12 and force the confectionery out the top. The handle 20 may be provided as a unitary piece with the plunger member 14, or they may be separate pieces. The handle 20 and plunger member 14 may be formed of different or the same materials. Although the handle 20 is shown in FIG. 1 as a long rod or cylinder, the shape is not so limited. The handle may be any desired shape and size known to those of ordinary skill in the art. In one embodiment, the handle has the same shape as the outer wall of the chamber 12.

Instead of a handle, the plunger member may include other embodiments (not shown), such as a dial or a push button. In one embodiment, the plunger member can include a dial or knob located on the outer wall of the chamber. To advance the confectionery product, the user would simply turn the dial, the dial being connected to a screw or other similar mechanism within the chamber, which in turn applies force to the plunger member toward one end of the chamber. In another embodiment, the plunger member can include a push button on the outer wall of the chamber. To advance the confectionery product, the user simply pushes the button to directly raise or lower the confectionery product out of the chamber. Alternatively, the button can be connected to a screw or other similar mechanism within the chamber, which in turn applies force to the plunger member up toward the top of the chamber.

The plunger member can be designed to dispense the confectionery in discrete increments, such as by using graduations on the outside of the chamber or notches on the inside, thereby permitting the user to obtain a precise measurement of the amount of each bite or even equal size bites. This feature is important to users for various reasons, for example, for those that wish to only consume a particular amount of the confectionery for dietary purposes, or for parents in controlling the amount of candy that their children consume. The device may also contain an attachment mechanism for easy transporting, such as a zipper, a snap, a hook and loop fastener, a clip, a pin, clasp, clamp, strap, or the like, or other releasable attachment to a back pack, clothing, a body part, or the like.

Also, the system is typically fairly sanitary since it can be reclosed after partial consumption. The delivery system of the present invention is preferably air- and moisture-resistant when closed after being opened.

Without wishing to be bound by theory, it is believed that the present delivery device with fat-based confectioneries could not be formed by traditional methods known to those of ordinary skill in the art. It has now advantageously been found that by filling the chamber from the bottom, fat-based confectionery devices of the present invention can be prepared, while minimizing or avoiding the entrapment of air within the product.

Advantageously, fat-based confectioneries may be molded in situ in the hollow interior of the delivery device, thereby reducing the manufacturing complexity and cost when first forming the confectionery and then disposing it within the device as previously done. In one preferred embodiment, the fat-based confectionery contacts at least about half, preferably about three-quarters, of the area of the wall(s) of the hollow interior of the delivery device when deposited. In another embodiment, substantially all of the wall area in the hollow interior contacts the fat-based confectionery disposed in the hollow interior. In this method, the fat content of the fat-based confectionery can be from about 0.1 to 100 weight percent fat, preferably from about 5 to 90 weight percent fat content. In one preferred embodiment, the fat-based confectionery includes from about 15 to 85 weight percent fat content. In one embodiment, the confectionery is poured into the device as a liquid, semi-solid, gel, or solid. The confectionery then typically becomes more solid, e.g., less tacky, or even crystalline through fat crystallization therein, or by cooling, drying, or gelling. The solids can include, for example, powder or granules. The confectionery may optionally contain inclusions, such as sugar confectionery or fat-based, or both.

In another embodiment, the confectioneries are co-deposited, i.e., simultaneously deposited into the device, e.g., by a co-extrusion nozzle. When more than one type of material is provided in the device, at least one fat-based confectionery product can be used. In one embodiment, the device contains a fat-based confectionery product that includes three layers, such as an inner filling, an outer filling, and a coating, at least one of which includes a fat-based confectionery product. For example, when an inner portion and a coating are deposited in the device, either the inner portion, the coating, or both can include a fat-based confectionery product. At the same time, either the inner portion or the coating can include a plurality of inclusions, nougat, fondant, or other sugar confection compositions, either in combination with the fat-based confectionery product or deposited as another portion. In a preferred embodiment, the coating is fat-based and the inner portion is a different material. In one embodiment, the coating is fat-based and the inner portion is a sugar confection, e.g., caramel, nougat, fondant, or the like, or a combination thereof. The fat-based confectionery can serve as a structure to hold the inner portion in place. In still another embodiment, the outer coating is fat-based and the inner portion is a fruit-based jelly, including e.g., strawberry, raspberry, cherry, blueberry, apple, or others, or mixtures thereof.

In another embodiment, multiple rings can be included in the fat-based confectionery product. Preferably, the rings are substantially or completely concentric along the direction of movement of the plunger member. For example, rings of a fat-based material such as chocolate can be alternated with rings of a sugar confectionery to provide a fat-based confectionery product. Another embodiment can include various portions of material deposited in various fashions, such as alternating, from the bottom of the hollow interior to the top. In sum, one of ordinary skill in the art will be able to provide a variety of fat-based confectionery products having a variety of appearances in the delivery device with reference to the disclosure herein.

In one embodiment, a material can be poured into the hollow interior of the device, such as an outer coating including chocolate. This outer coating can coat a portion or all of the walls of the device. Next, any desired constituents can be added, at least primarily, to the inside of the coating. This inner portion of the confectionery can be a liquid, semi-solid, gel, or solid, capable of being disposed inside the device and at least primarily inside the coating adhering to the inner walls of the device. In one embodiment, the outer coating is disposed using stenciling or a mask to leave portions of the walls of the device uncoated. Then, when the inner portion is deposited in the device, a portion of these inner constituents can also coat the uncoated areas of the walls. The material can remain in its original state or become more solid or even crystalline through crystallization, cooling, drying, or gelling to final form in the package. When the coating solidifies, the confectionery has taken on the shape of the delivery device. In one embodiment, the inner and outer materials used to form the confectionery product can have the same composition or a different composition. When they are the same composition, the same or different inclusions can be disposed in each composition. Also, when more than one layer is present, and particularly when the multiple layers are made of the same composition, the color of the layers can differ or even alternate to provide a more visually appealing product.

The term “about,” as used herein, should generally be understood to refer to both numbers in a range of numerals. Moreover, all numerical ranges herein should be understood to include each whole integer within the range.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A confectionery product comprising:
a fat-based confectionery comprising at least one portion having from about 15 to 90 weight percent fat content; and
a delivery system for the confectionery, the delivery system comprising:
a first chamber having first and second ends and a hollow interior within which the fat-based confectionery is disposed; and
a slidable plunger member positioned in the first end of the chamber for engagement with the confectionery, such that when force is applied to the plunger member to move it toward the second end of the chamber, the confectionery is moved toward and out of the second end of the chamber and is exposed for consumption.

2. The confectionery product of claim 1, further comprising a handle attached to the plunger member on a side opposite that which contacts the fat-based confectionery.

3. The confectionery product of claim 1, further comprising a dial or a button positioned on an outside surface of the chamber.

4. The confectionery product of claim 1, further comprising a removable end seal covering the second end of the chamber to protect the confectionery when the delivery system is not in use.

5. The confectionery product of claim 1, wherein the chamber, plunger member and confectionery are shaped as a circle, oval, polygon, trapezoid, star, cross, or character shape, when viewed in cross-section taken perpendicularly along the length of the chamber.

6. The confectionery product of claim 1, wherein the chamber is made of a transparent material.

7. The confectionery product of claim 1, wherein at least one of the chamber or plunger member comprises polyethylene, polypropylene, polystyrene, polyethylene terephthalate, or a combination thereof.

8. The confectionery product of claim 1, further comprising at least one additional chamber adjacent to the first chamber.

9. The confectionery product of claim 1, further comprising graduations on the first chamber to indicate amounts of fat-based confectionery therein.

10. The confectionery product of claim 1, wherein the portion comprises a layer.

11. A method of forming a confectionery product which comprises:
providing a chamber having first and second ends and a hollow interior;
depositing a fat-based confectionery within the hollow interior of the chamber; and
providing a slidable plunger member positioned in a first end of the chamber, such that when force is applied to the plunger member to move it toward the second end of the chamber, the fat base confectionery is forced to move toward the second end and out of the chamber to become exposed for consumption.

12. The method of claim 11, wherein the chamber and fat based confectionery are correspondingly shaped as a circle, oval, polygon, star, cross or character shape, when viewed in cross-section taken perpendicular to the length of the chamber.

13. The method of claim 11, which further comprises making the chamber out of a transparent material so that the fat based confectionery is visible.

14. The method of claim 11, which further comprises providing an additional chamber.

15. The method of claim 11, wherein the depositing step comprises an in situ molding of the fat-based confectionery in the chamber utilizing the chamber as a mold.

16. The method of claim 15, wherein the in situ molding comprises:
coating the interior of the chamber with a first confectionery; and
providing a second confectionery into the hollow interior of the coated chamber to form the final shape of the confectionery;
wherein at least one of the confectioneries is fat-based.

17. The method of claim 15, wherein the in situ molding comprises:
co-depositing a first confectionery to coat the interior of the chamber and the second confectionery within the hollow interior of the coated chamber to form the final shape of the confectionery;
wherein at least one of the confectioneries is fat-based.

18. The method of claim 16, wherein at least one of the first and second confectioneries comprises chocolate.

19. The method of claim 16, wherein the first and second confectioneries are different compositions.

20. The method of claim 15, wherein the fat-based confectionery comprises one or more inclusions.

21. A method of dispensing a fat-based confectionery for consumption which comprises:
forming a confectionery product according to claim 11; and
pushing the plunger member through the chamber to force the confectionery out of the chamber to expose it for consumption.
